(19) United States
(12) Patent Application Publication
(10) Pub. No.: US 2025/0133388 A1
(43) Pub. Date: Apr. 24, 2025

(54) CAPABILITY INDICATION AND DETERMINATION METHODS AND APPARATUS, COMMUNICATION APPARATUS, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/691,950

(22) PCT Filed: Sep. 16, 2021
(86) PCT No.: PCT/CN2021/118884

§ 371 Date: Mar. 14, 2024

(51) Int. Cl. H04W 8/18; H04W 8/24; H04W 88/06

(52) U.S. Cl. CPC H04W 8/183; H04W 8/24; H04W 88/06

(57) ABSTRACT

The present disclosure relates to capability indication and determination methods and apparatus, a communication apparatus, and a storage medium. The capability indication method comprises: sending first capability information to a core network, the first capability information being used to indicate the support capabilities of a base station for multi-SIM card connection handover by a terminal.

### CROSS-REFERENCE TO RELATED APPLICATION

The application is a U.S. National Stage of International Application No. PCT/CN2021/118884 filed on Sep. 16, 2021, the entire content of which is incorporated herein by reference for all purposes.

### BACKGROUND

### Technical Field

The present disclosure relates to the field of communication technologies, and in particular, relates to a capability indicating method, a capability determining method, a capability indicating apparatus, a capability determining apparatus, a communication apparatus, and a computer-readable storage medium.

### Description of the Related Art

In a multi-card terminal, a plurality of Subscriber Identity Module (SIM) cards can be set, and the terminal can communicate through the plurality of SIM cards. For example, the terminal is set with SIM card #1 and SIM card #2, and the terminal can perform the communication operation using SIM card #1, and also can perform the communication operation using SIM card #2.

### SUMMARY

Embodiments of the present disclosure propose a capability indicating method, a capability determining method, a capability indicating apparatus, and a capability determining apparatus, a communication apparatus and a computer-readable storage medium to solve the technical problems in the related art.

According to a first aspect of the embodiments of the present disclosure, a capability indication method is proposed, executed by a base station, the method includes sending first capability information to a core network, where the first capability information is used to indicate a support capability of the base station for a terminal to perform a multi-SIM card connection switching.

According to a second aspect of the embodiments of the present disclosure, a capability indication method is proposed, executed by a core network, the method includes: sending second capability information to a base station, where the second capability information is used to indicate a support capability of the core network for a terminal to perform a multi-SIM card connection switching.

According to a third aspect of the embodiments of the present disclosure, a capability determining method is proposed, executed by a terminal, the method includes: receiving capability information obtained by a first network-side device from a second network-side device; and determining, according to the capability information, a support capability of the second network-side device for the terminal to perform a multi-SIM card connection switching.

According to a fourth aspect of the embodiments of the present disclosure, a capability indicating apparatus is proposed, including one or more processors, the processors are configured to send first capability information to a core network, where the first capability information is used to indicate a support capability of the base station for a terminal to perform a multi-SIM card connection switching.

According to a fifth aspect of the embodiments of the present disclosure, a capability indicating apparatus is proposed, including one or more processors, the processors are configured to: send second capability information to a base station, where the second capability information is used to indicate a support capability of a core network for a terminal to perform a multi-SIM card connection switching.

According to a sixth aspect of the embodiments of the present disclosure, a capability determining apparatus is proposed, including one or more processors, the processors are configured to receive capability information obtained by a first network-side device from a second network-side device; and determine, according to the capability information, a support capability of the second network-side device for a terminal to perform a multi-SIM card connection switching.

According to a seventh aspect of the embodiments of the present disclosure, a communication apparatus is proposed, including a processor and a memory for storing a computer program. When the computer program is executed by the processor, the above-mentioned capability indication method performed by the base station is implemented.

According to an eighth aspect of the embodiments of the present disclosure, a communication apparatus is proposed, including a processor and a memory for storing a computer program. When the computer program is executed by the processor, the above-mentioned capability indication method performed by the core network is implemented.

According to a ninth aspect of the embodiments of the present disclosure, a communication apparatus is proposed, including a processor and a memory for storing a computer program. When the computer program is executed by the processor, the above-mentioned capability determining method is implemented.

According to a tenth aspect of the embodiments of the present disclosure, a non-transitory computer-readable storage medium is provided for storing a computer program, and when the computer program is executed by a processor, the steps in the above-mentioned capability indication method performed by the base station are implemented.

According to an eleventh aspect of the embodiments of the present disclosure, a non-transitory computer-readable storage medium is provided for storing a computer program, and when the computer program is executed by a processor, the steps in the above-mentioned capability indication method performed by the core network are implemented.

According to a twelfth aspect of the embodiments of the present disclosure, a non-transitory computer-readable storage medium is provided for storing a computer program, and when the computer program is executed by a processor, the steps in the above-mentioned capability determining method are implemented.

According to the embodiments of the present disclosure, the base station can generate the first capability information according to its ability to support multi-SIM card connection switching, and then send the first capability information to the core network. After the core network receives the first capability information, it can determine, according to the first capability information, the capability of the base station to support connection switching between multiple SIM cards for the terminal.

Since the core network can receive the first capability information reported by at least one base station, it can also determine the support capability of at least one base station for multi-SIM card connection switching, and then can subsequently inform the terminal of the support capability of the base station for multi-SIM card connection switching as required, so that the terminal determines whether to access the target base station accordingly.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic flowchart of a capability indication method according to an embodiment of the present disclosure.

FIG. 2 is a schematic flowchart of another capability indication method according to an embodiment of the present disclosure.

FIG. 3 is a schematic flowchart of another capability indication method according to an embodiment of the present disclosure.

FIG. 4 is a schematic flowchart of another capability indication method according to an embodiment of the present disclosure.

FIG. 5 is a schematic flowchart of another capability indication method according to an embodiment of the present disclosure.

FIG. 6 is a schematic flowchart of another capability indication method according to an embodiment of the present disclosure.

FIG. 7 is a schematic flowchart of another capability indication method according to an embodiment of the present disclosure.

FIG. 8 is a schematic flowchart of a capability indication method according to an embodiment of the present disclosure.

FIG. 9 is a schematic flowchart of another capability indication method according to an embodiment of the present disclosure.

FIG. 10 is a schematic flowchart of another capability indication method according to an embodiment of the present disclosure.

FIG. 11 is a schematic flowchart of another capability indication method according to an embodiment of the present disclosure.

FIG. 12 is a schematic flowchart of another capability indication method according to an embodiment of the present disclosure.

FIG. 13 is a schematic flowchart of another capability indication method according to an embodiment of the present disclosure.

FIG. 14 is a schematic flowchart of a capability determining method according to an embodiment of the present disclosure.

FIG. 15 is a schematic flowchart of another capability determining method according to an embodiment of the present disclosure.

FIG. 16 is a schematic flowchart of another capability determining method according to an embodiment of the present disclosure.

FIG. 17 is a schematic block diagram of an apparatus for capability indication according to an embodiment of the present disclosure.

FIG. 18 is a schematic block diagram of an apparatus for capability determination according to an embodiment of the present disclosure.

### DETAILED DESCRIPTION OF THE PREFERRED EMBODIMENTS

Referring now to the drawings, wherein like reference numerals designate identical or corresponding parts throughout the several views.

The following will clearly and completely describe the technical solutions in the embodiments of the present disclosure with reference to the accompanying drawings in the embodiments of the present disclosure. Apparently, the described embodiments are only some of the embodiments of the present disclosure, not all of them. Based on the embodiments in the present disclosure, all other embodiments obtained by those skilled in the art without making creative efforts belong to the protection scope of the present disclosure.

Terms used in the embodiments of the present disclosure are for the purpose of describing specific embodiments only, and are not intended to limit the embodiments of the present disclosure. As used in the embodiments of the present disclosure and the appended claims, the singular forms “a” and “the” are also intended to include the plural unless the context clearly dictates otherwise. It should also be understood that the term “and/or” as used herein refers to and includes any and all possible combinations of one or more of the associated listed items.

It should be understood that although the embodiments of the present disclosure may use the terms first, second, third, etc. to describe various information, the information should not be limited to these terms. These terms are only used to distinguish information of the same type from one another. For example, without departing from the scope of the embodiments of the present disclosure, a first SIM card may also be called a second SIM card, and similarly, a second SIM card may also be called a first SIM card. Depending on the context, the word “if” as used herein may be interpreted as “in time of . . . ” or “when” or “in response to a determination.”

For the purpose of brevity and ease of understanding, the terms used herein when representing a size relationship are “greater than” or “less than”, “higher than” or “lower than”. But for those skilled in the art, it can be understood that the term “greater than” also covers the meaning of “greater than or equal to”, and “less than” also covers the meaning of “less than or equal to”; the term “higher than” covers the meaning of “higher than or equal to”, and “lower than” also covers the meaning of “lower than or equal to”.

In some scenarios, the terminal may need to perform communication using SIM card #2 when performing the communication operation using SIM card #1, which requires the terminal to perform multi-SIM card connection switching, switching from performing the communication operation using SIM card #1 to performing the communication using SIM card #2.

FIG. 1 is a schematic flowchart of a capability indication method according to an embodiment of the present disclosure. The capability indication method shown in this embodiment can be performed by a base station, and the base station can communicate with communication devices such as terminals and core networks. The terminals include but are not limited to mobile phones, tablet computers, wearable devices, sensors. Internet of Things devices, and other communication devices. The base station includes but not limited to base stations in communication systems such as 4G, 5G, and 6G.

In an embodiment, the terminal may be provided with a plurality of SIM cards, which may be traditional SIM cards or eSIM cards, that is, embedded SIM cards.

The technical solutions of the present disclosure will be exemplarily described below mainly under the condition that a plurality of SIM cards includes a first SIM card and a second SIM card. The first SIM card and the second SIM card do not specifically refer to a certain SIM card, but are used to represent any two different SIM cards among the plurality of SIM cards. The first SIM card and the second SIM card may belong to the same operator, or may belong to different operators, which can be selected according to needs.

As shown in FIG. 1, the capability determining method may include the following steps.

In step S101, first capability information is sent to a core network, where the first capability information is used to indicate a support capability of the base station for the terminal to perform a multi-SIM card connection switching.

In an embodiment, the terminal is provided with a plurality of SIM cards, the plurality of SIM cards at least includes a first SIM card and a second SIM card, and the multi-SIM card connection switching includes switching to the second SIM card for communication operation when performing the communication operation by the first SIM card (in this case, the communication operation performed by the first SIM card can be interrupted). It should be noted that the multi-SIM card connection switching is not limited to the above situation, for example, it may also include: when performing the communication operation by the first SIM card, activating the second SIM card to perform the communication operation at the same time (in this case, the communication operation performed by the first SIM card may not be interrupted). The technical solutions of the present disclosure will be exemplarily described below mainly for the case where the multi-SIM card connection switching includes switching to the second SIM card for the communication operation when the first SIM card is used for the communication operation.

In view of this situation, the network-side device such as the base station and the core network needs to perform an appropriate operation and configuration for the terminal. Taking the network-side device including a base station as an example, for example, when a terminal communicates with a first base station through the first SIM card, and it needs to communicate with a second base station through the second SIM card, for example, to receive the system information sent by the second base station, then the communication operation between the first base station and the first SIM card needs to be interrupted for a period of time, and after the communication with the first base station through the second SIM card is completed, the first base station resumes the communication operation with the first SIM card.

However, not all network-side devices support recovery after interruption of the communication operation of the first SIM card. For example, some base stations can make appropriate operations and configurations for the terminal to perform multi-SIM connection switching, that is, support the multi-SIM card connection switching, and some base stations cannot, that is, do not support the multi-SIM card connection switching. And for the network-side devices that support the multi-SIM card connection switching, the specific support for multi-SIM card connection switching may also be different. For example, the base station can support multi-SIM card connection switching when the first SIM card leaves the connected state, or support multi-SIM card connection switching when the first SIM card remains in the connected state.

Considering the above technical problems, in the embodiments of the present disclosure, the base station can generate the first capability information according to its ability to support multi-SIM card connection switching, and then send the first capability information to the core network. After receiving the first capability information, the core network can determine the support capability of the base station for the terminal to perform the multi-SIM card connection switching according to the first capability information, for example, whether it supports multi-SIM card connection switching, for example, in the case of supporting multi-SIM card connection switching, under what conditions does it specifically supports multi-SIM card connection switching.

Since the core network may receive the first capability information reported by at least one base station, it can determine the support capability of at least one base station for multi-SIM card connection switching, and then can subsequently inform the terminal of the support capability of the base station for multi-SIM card connection switching as required, for example, the terminal can receive the information sent by the core network, but temporarily cannot receive the information sent by the base station. For example, the core network determines that the terminal will enter the signal coverage area of the target base station, then it can inform the terminal of the support capability of the target base station for multi-SIM card connection switching, so that the terminal can determine whether to access the target base station, whether to report the information of multi-SIM card to the target base station, whether to be able to request the target base station for a gap of multi-SIM card connection switching, etc.

In an embodiment, the core network may send the first capability information of the base station for multi-SIM card connection switching to the terminal. For example, the terminal may receive the capability information of a plurality of base stations for multi-SIM card connection switching from the core network, and the terminal may determine its own support capability for multi-SIM card connection switching, and then determine the base station whose support capability for multi-SIM card connection switching matches the support capability for multi-SIM card connection switching of the terminal.

For example, the terminal itself supports multi-SIM card connection switching in the case that the first SIM card remains in the connected state. Among the received capability information of a plurality of base stations for multi-SIM card connection switching, it can be determined that a base station X supports multi-SIM card connection switching in the case that the first SIM card remains in the connected state, and a base station Y only supports multi-SIM card connection switching in the case that the first SIM card leaves the connected state. Then it may be determined that the support capability of the base station X for multi-SIM connection switching matches the support capability of the terminal per se for multi-SIM connection switching, but the support capability of the base station Y for multi-SIM connection switching does not match the terminal's own support capability for multi-SIM connection switching.

Furthermore, for the base station X and the base station Y, the terminal may preferentially select the base station X to access, for example, it may preferentially choose to camp on the cell corresponding to the base station X, for example, it may preferentially select the cell corresponding to the base station X for cell reselection. Accordingly, it can be ensured that after the terminal accesses the base station X, when performing multi-SIM card connection switching, after the terminal reports the information of multi-SIM card connection switching to the base station X, the base station X has the ability to perform reasonable configuration for the terminal to perform multi-SIM card connection switching.

The information for performing multi-SIM card connection switching includes but not limited to at least one of the following: a type of communication operation performed through the second SIM card, an identity of the second SIM card, or a duration of the communication operation performed through the second SIM card. The configuration corresponding to the multi-SIM card connection switching includes gap-related information for the terminal to perform multi-SIM card connection switching, such as a gap start position, a gap end position, a gap duration, a gap type (periodic, aperiodic), etc.

In an embodiment, the first capability information is further used to indicate a support capability of other base station(s) connected to the base station for the terminal to perform the multi-SIM card connection switching.

The communication connection can be established between the base stations by establishing an interface. For example, an interface such as an X2 interface or an Xn interface can be established between the base station A and the base station B. For example, the base station B may be a neighboring base station of the base station A. The base station A and the base station B may communicate through the interface. For example, the base station B may inform the base station A of its capability to support multi-SIM card connection switching, and then the base station A may carry the support capability of the base station A for multi-SIM card connection switching and the support capability of the base station B for multi-SIM card connection switching in the first capability information and send it to the core network.

Accordingly, when there is a communication connection between the core network and one base station, the support capability of at least one base station for multi-SIM card connection switching can be obtained, which is conducive to improving the use efficiency of the communication resource between the base station and the core network.

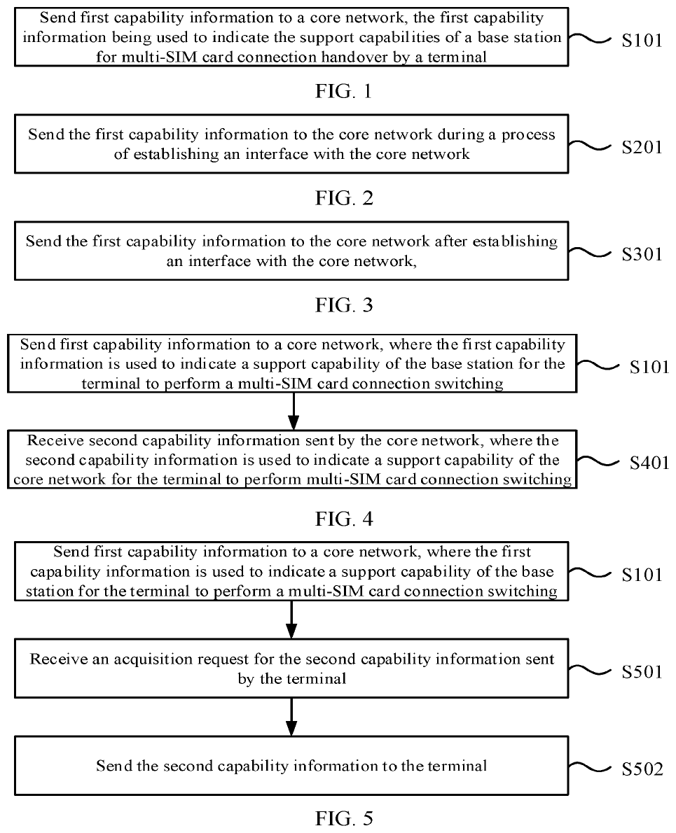

FIG. 2 is a schematic flowchart of another capability indication method according to an embodiment of the present disclosure. As shown in FIG. 2, sending the first capability information to the core network includes the following steps.

In step S201, during a process of establishing an interface with the core network, the first capability information is sent to the core network.

In an embodiment, the base station may send the first capability information to the core network during the process of establishing an interface with the core network. Accordingly, the core network is enabled to determine the support capability of the base station for multi-SIM card connection switching as soon as possible.

In an embodiment, in the case that the base station includes an evolved universal terrestrial radio access network (E-UTRAN) base station, the first capability information can be carried in an S1 interface setup request (S1 SETUP REQUEST) signaling.

TABLE 1

| IE/Group | | | IE type | Semantics | | Assigned |
|---|---|---|---|---|---|---|
| Name | Presence | Range | and reference | description | Criticality | Criticality |
| Message Type | M | | 9.2.1.1 | | YES | reject |
| Global eNB ID | M | | 9.2.1.37 | | YES | reject |
| . . . . . . | . . . . . . | . . . . . . | . . . . . . | . . . . . . | . . . . . . | . . . . . . |
| Leaving Capability | O | | 9.x.x.x | | YES | ignore |

For example, the S1 interface setup request signaling may be as shown in the above Table 1, which carries information such as a Message Type, a global base station identification (Global eNB ID) (only part of the information carried by the signaling is shown in the table), and may also carry Leaving Capability, i.e., the first capability information. It can be understood that each element in Table 1 exists independently, and these elements are exemplarily listed in the same table, but it does not mean that all elements in the table must exist at the same time as shown in the table. The value of each of these elements is not dependent on the value of any other element in Table 1. Therefore, those skilled in the art can understand that the value of each element in Table 1 is an independent embodiment.

In an embodiment, in the cast that the base station includes a New Radio (NR) base station, the first capability information is carried in an NG interface setup request (NG SETUP REQUEST) signaling.

TABLE 2

| IE/Group | | | IE type | Semantics | | Assigned |
|---|---|---|---|---|---|---|
| Name | Presence | Range | and reference | description | Criticality | Criticality |
| Message Type | M | | 9.3.1.1 | | YES | reject |
| Global RAN Node ID | M | | 9.3.1.5 | | YES | reject |
| . . . . . . | . . . . . . | . . . . . . | . . . . . . | . . . . . . | . . . . . . | . . . . . . |
| Leaving Capability | O | | 9.x.x.x | | YES | ignore |

For example, the NG interface setup request signaling may be as shown in the above table 2, which carries information such as a Message Type, a global radio access node identification (Global RAN Node ID) (only part of the information carried by the signaling is shown in the table), and may also carry Leaving Capability, which is the first capability information. It can be understood that each element in Table 2 exists independently, and these elements are exemplarily listed in the same table, but it does not mean that all elements in the table must exist at the same time as shown in the table. The value of each of these elements is not dependent on the value of any other element in Table 2. Therefore, those skilled in the art can understand that the value of each element in Table 2 is an independent embodiment.

FIG. 3 is a schematic flowchart of another capability indication method according to an embodiment of the present disclosure. As shown in FIG. 3, sending the first capability information to the core network includes the following step.

In step S301, after establishing an interface with the core network, the first capability information is sent to the core network.

In an embodiment, the base station may send the first capability information to the core network after establishing an interface with the core network. Accordingly, the information carried in the signaling during the establishment of the interface can be reduced, thereby reducing the amount of information to be parsed by the core network during the establishment of the interface, which is beneficial to speeding up the establishment of the interface.

In an embodiment, in the case that the base station includes an E-UTRAN base station, the first capability information is carried in a base station configuration update (ENB CONFIGURATION UPDATE) signaling. When updating the configuration, the base station may send the base station configuration update signaling to the core network, and carry the first capability information in the signaling and send it to the core network. In addition to the base station configuration update signaling, the base station may also carry the first capability information in other signaling and send it to the core network as required.

In an embodiment, in the case that the base station includes an NR base station, the first capability information is carried in a radio access network configuration update (RAN CONFIGURATION UPDATE) signaling. When updating the radio access network configuration, the base station may send the radio access network configuration update signaling to the core network, and carry the first capability information in the signaling and send it to the core network. In addition to the radio access network configuration update signaling, the base station may also carry the first capability information in other signaling and send it to the core network as required.

FIG. 4 is a schematic flowchart of another capability indication method according to an embodiment of the present disclosure. As shown in FIG. 4, the method also includes the following step.

In step S401, second capability information sent by the core network is received, where the second capability information is used to indicate a support capability of the core network for the terminal to perform multi-SIM card connection switching.

In an embodiment, the core network may generate second capability information according to its capability to support multi-SIM card connection switching, and then send the second capability information to the base station. After receiving the second capability information, the base station may determine the support capability of the core network for the terminal to perform multi-SIM card connection switching according to the second capability information, for example, whether it supports multi-SIM card connection switching, for example, in the case of supporting multi-SIM card connection switching, under what conditions does it support multi-SIM card connection switching.

In an embodiment, the method further includes sending the second capability information to the terminal. It should be noted that the base station may also send the first capability to the terminal.

After the base station determines the support capability of the core network for multi-SIM connection switching, it can subsequently inform the terminal of the support capability of the base station for multi-SIM connection switching as needed, so that the terminal can determine whether to access the core network accordingly, such as registering, attaching to the core network.

In an embodiment, the base station may send the second capability information of a plurality of core networks for multi-SIM card connection switching to the terminal, and the terminal may determine its own support capability for multi-SIM card connection switching, and then determine the core network whose support capability for the multi-SIM card connection switching matches the support capability of the terminal for multi-SIM card connection switching.

For example, the terminal itself supports multi-SIM card connection switching in the case that the first SIM card remains in the connected state. From the received capability information of a plurality of core networks for multi-SIM card connection switching, it can be determined that the core network X supports the multi-SIM card connection switching in the case that the first SIM card remains in the connected state, and the core network Y only supports multi-SIM card connection switching in the case that the first SIM card leaves the connected state. Then, it can be determined that the support capability of the core network X for the multi-SIM card connection switching is matched with the support capability of the terminal itself for the multi-SIM card connection switching.

Furthermore, for the core network X and the core network Y, the terminal may preferentially select the core network X to access, for example, may preferentially select the core network X for registration or attachment. Accordingly, it can be ensured that after the terminal accesses the core network X, when performing multi-SIM card connection switching, after reporting the information of the multi-SIM card connection switching to the core network X, the core network X has the ability to make a reasonable configuration for the terminal to perform multi-SIM card connection switching.

In an embodiment, the second capability information is carried in Radio Resource Control (RRC) signaling and/or System Information (SI) and sent to the terminal. That is to say, the base station may choose to carry the second capability information in SI and send it to the terminal through broadcast, or choose to carry the second capability information in RRC signaling and send it to the terminal through unicast.

FIG. 5 is a schematic flowchart of another capability indication method according to an embodiment of the present disclosure. As shown in FIG. 5, the second capability information is carried in RRC signaling and sent to the terminal, and sending the second capability information to the terminal includes the following steps.

In step S501, an acquisition request for the second capability information sent by the terminal is received.

In step S502, the second capability information is sent to the terminal.

In an embodiment, in the case that the base station carries the second capability information through RRC signaling, since it is sent in unicast mode, there is already a communication connection with the terminal before sending, then it can first determine whether the acquisition request sent by the terminal is received, and in the case that the acquisition request is received, it may be determined that the terminal needs to acquire the second capability information, and then the second capability information is carried in the RRC signaling and sent to the terminal. Accordingly, the waste of communication resources caused by sending the second capability information to the terminal in the case that the terminal does not need to acquire the second capability information can be avoided.

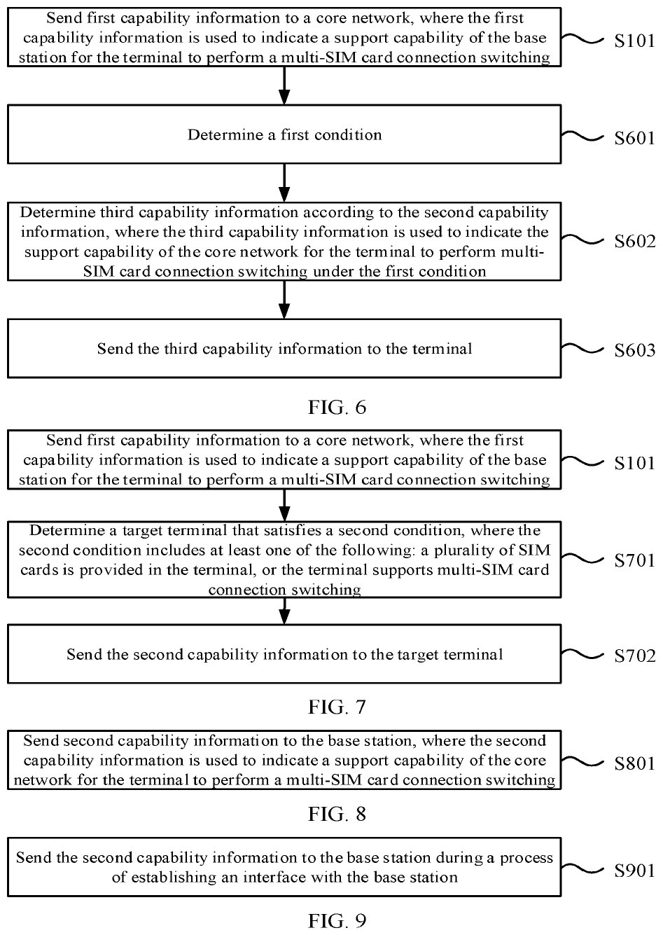

FIG. 6 is a schematic flowchart of another capability indication method according to an embodiment of the present disclosure. As shown in FIG. 6, sending the second capability information to the terminal further includes the following steps.

In step S601, a first condition is determined.

In step S602, third capability information is determined according to the second capability information, where the third capability information is used to indicate the support capability of the core network for the terminal to perform multi-SIM card connection switching under the first condition.

In step S603, the third capability information is sent to the terminal.

In an embodiment, the second capability information may carry a plurality of support capabilities, for example, it may include support for multi-SIM card connection switching, support for multi-SIM card connection switching in the case that the first SIM card remains in the connected state, support for multi-SIM card connection switching in the case that the first SIM card leaves the connected state, etc. The terminal may not need to determine the support capability of multi-SIM card connection switching for each situation, but only hopes to determine the support capacity of the multi-SIM card connection switching for some situations.

For example, the terminal itself supports multi-SIM card connection switching under the first condition, then the terminal may only need to determine whether the core network also supports multi-SIM card connection switching under the first condition, and is not interested in multi-SIM card connection switching under other conditions. In this case, the base station may determine the first condition. For example, the first condition may be reported by the terminal, for example, reported by being included in the acquisition request, or may be pre-agreed with the terminal. Thus, the base station may determine the third capability information in the second capability information based on the first condition, and the determined third capability information is the support capability of multi-SIM card connection switching under the first condition in the second capability information, and then the third capability information is sent to the terminal.

Since the third capability information is part of the capability information in the second capability information, it generally occupies relatively few communication resources, which can meet the needs of the terminal on the one hand, and help save communication resources on the other hand.

FIG. 7 is a schematic flowchart of another capability indication method according to an embodiment of the present disclosure. As shown in FIG. 7, sending the second capability information to the terminal includes the following steps.

In step S701, a target terminal that satisfies a second condition is determined, where the second condition includes at least one of the following: a plurality of SIM cards is provided in the terminal, or the terminal supports multi-SIM card connection switching.

In step S702, the second capability information is sent to the target terminal.

In an embodiment, the base station may selectively send the second capability information to the terminal, for example, it may determine a target terminal that meets the second condition, for example, the target terminal may refer to a terminal equipped with a plurality of SIM cards, or may refer to a terminal that supports multi-SIM card connection switching. For these terminals, it is possible for the terminal to perform multi-SIM card connection switching, and then it is necessary to obtain the second capability information. Therefore, the second capability information can only be sent to these terminals, which is beneficial to avoiding waste of communication resources caused by sending the second capability information to the terminal that does not need to obtain the second capability information.

FIG. 8 is a schematic flowchart of a capability indication method according to an embodiment of the present disclosure. The capability indication method shown in this embodiment can be performed by a core network, and the core network can communicate with terminals and base stations. The core network includes but not limited to core networks in communication systems such as 4G, 5G, and 6G. The terminal includes but not limited to communication apparatuses such as mobile phones, tablet computers, wearable devices, sensors, and Internet of Things devices.

As shown in FIG. 8, the capability indication method may include the following steps.

In step S801, second capability information is sent to the base station, where the second capability information is used to indicate a support capability of the core network for the terminal to perform a multi-SIM card connection switching.

In an embodiment, the terminal is provided with a plurality of SIM cards, the plurality of SIM cards at least includes a first SIM card and a second SIM card, and the multi-SIM card connection switching includes switching to the second SIM card for communication operation when performing the communication operation through the first SIM card (in this case, the communication operation performed by the first SIM card can be interrupted). It should be noted that the multi-SIM card connection switching is not limited to the above situation, for example, it may also include: when the first SIM card is used for communication operation, activating the second SIM card to perform the communication operation at the same time (in this case, the communication operation performed by the first SIM card may not be interrupted). The technical solutions of the present disclosure are exemplarily described below mainly for the case where the multi-SIM card connection switching includes switching to the second SIM card for the communication operation when the first SIM card is used for the communication operation.

In view of this situation, the network-side devices, such as the base station and the core network, need to perform appropriate operations and configurations for the terminal. However, not all network-side devices support recovery after interruption of the communication operation of the first SIM card. For example, some core networks can make appropriate operations and configurations for the terminal to perform multi-SIM connection switching, that is, support multi-SIM card connection switching, and some core networks cannot, that is, do not support multi-SIM card connection switching. And for the network-side devices that support multi-SIM card connection switching, the specific support for multi-SIM card connection switching may also be different. For example, the core network can support multi-SIM card connection switching when the first SIM card leaves the connected state, or support multi-SIM card connection switching when the first SIM card remains in the connected state.

Considering the above technical problems, in the embodiments of the present disclosure, the core network can generate the second capability information according to its capability to support multi-SIM card connection switching, and then send the second capability information to the base station. After receiving the second capability information, the base station can determine the support capability of the core network for the terminal to perform multi-SIM card connection switching according to the second capability information, for example, whether it supports multi-SIM card connection switching, for example, in the case of supporting multi-SIM card connection switching, under what conditions does it specifically supports multi-SIM card connection switching, and then the base station sends the second capability information to the terminal subsequently.

Because the base station can receive the second capability information reported by at least one core network, it can determine the support capability of at least one core network for multi-SIM card connection switching, and then it can notify the support capability of the core network for multi-SIM card connection switching to the terminal subsequently as needed. For example, the terminal can receive the information sent by the base station, but temporarily cannot receive the information sent by the core network, so that the terminal can select an appropriate core network to attach or register accordingly.

In an embodiment, the base station may send the second capability information of the core network for multi-SIM card connection switching to the terminal. For example, the terminal may receive the capability information of a plurality of core networks for multi-SIM card connection switching from the base station, and the terminal may determine its own support capability for multi-SIM card connection switching, and then determine the core network whose support capability for multi-SIM card connection switching matches the support capability of the terminal for multi-SIM card connection switching.

For example, the terminal itself supports multi-SIM card connection switching in the case that the first SIM card remains in the connected state. From the received capability information of a plurality of core networks for multi-SIM card connection switching, it can determine that the core network X supports the multi-SIM card connection switching in the case that the first SIM card remains in the connected state, and the core network Y only supports multi-SIM card connection switching in the case that the first SIM card leaves the connected state. Then, it can be determined that the support capability of the core network X for the multi-SIM card connection switching is matched with the support capability of the terminal itself for the multi-SIM card connection switching.

Furthermore, for the core network X and the core network Y, the terminal may preferentially select the core network X to access, for example, may preferentially select to register or attach to the core network X. Accordingly, it can be ensured that after the terminal accesses the core network X, when performing multi-SIM card connection switching, after reporting the information of the multi-SIM card connection switching to the core network X, the core network X has the ability to make a reasonable configuration for the terminal to perform multi-SIM card connection switching.

The information for performing multi-SIM card connection switching includes but not limited to at least one of the following: a type of communication operation performed through the second SIM card, an identity of the second SIM card, or a duration of the communication operation performed through the second SIM card. The configuration corresponding to the multi-SIM card connection switching includes gap-related information for the terminal to perform multi-SIM card connection switching, such as a gap start position, a gap end position, a gap duration, a gap type (periodic, aperiodic), etc.

FIG. 9 is a schematic flowchart of another capability indication method according to an embodiment of the present disclosure. As shown in FIG. 9, sending the second capability information to the base station includes the following steps.

In step S901, the second capability information is sent to the base station during a process of establishing an interface with the base station.

In an embodiment, the core network may send the second capability information to the base station during the process of establishing an interface with the base station. Accordingly, the base station is made to determine the support capability of the core network for multi-SIM card connection switching as soon as possible.

In an embodiment, in the case that the core network includes an E-UTRAN core network, the second capability information can be carried in the S1 interface setup response (S1 SETUP RESPONSE) signaling.

TABLE 3

| IE/Group | | | IE type and | Semantics | | Assigned |
|---|---|---|---|---|---|---|
| Name | Presence | Range | reference | description | Criticality | Criticality |
| Message Type | M | | 9.2.1.1 | | YES | reject |
| MME Name | O | | PrintableString | | YES | ignore |
| | | | (SIZE(1 . . . 150, . . . )) | | | |
| . . . . . . | . . . . . . | . . . . . . | . . . . . . | . . . . . . | . . . . . . | . . . . . . |
| Leaving | O | | 9.x.x.x | | YES | ignore |
| Capability | | | | | | |

For example, the S1 interface setup response signaling can be as shown in the above table 3, which carries information such as a Message Type, a core network name (MME Name) (only part of the information carried by the signaling is shown in the table), and can also carry Leaving Capability, that is, the second capability information. It can be understood that each element in Table 3 exists independently, and these elements are exemplarily listed in the same table, but it does not mean that all elements in the table must exist at the same time as shown in the table. The value of each of these elements is not dependent on the value of any other element in Table 3. Therefore, those skilled in the art can understand that the value of each element in Table 3 is an independent embodiment.

In an embodiment, in the case that the core network includes the NR core network, the second capability information is carried in the NG interface setup response (NG SETUP RESPONSE) signaling.

TABLE 4

| IE/Group | | | IE type | Semantics | | Assigned |
|---|---|---|---|---|---|---|
| Name | Presence | Range | and reference | description | Criticality | Criticality |
| Message Type | M | | 9.3.1.1 | | YES | reject |
| AMF Name | M | | 9.3.3.21 | | YES | reject |
| . . . . . . | . . . . . . | . . . . . . | . . . . . . | . . . . . . | . . . . . . | . . . . . . |
| Leaving Capability | O | | 9.x.x.x | | YES | ignore |

For example, the NG interface setup response signaling may be as shown in the above-mentioned Table 2, which carries information such as the Message Type, an access mobility management function name (AMF Name) (only part of the information carried by the signaling is shown in the table), and it can carry Leaving Capability, that is, the first capability information. It can be understood that each element in Table 4 exists independently, and these elements are exemplarily listed in the same table, but it does not mean that all elements in the table must exist at the same time as shown in the table. The value of each of these elements is not dependent on the value of any other element in Table 4. Therefore, those skilled in the art can understand that the value of each element in Table 4 is an independent embodiment.

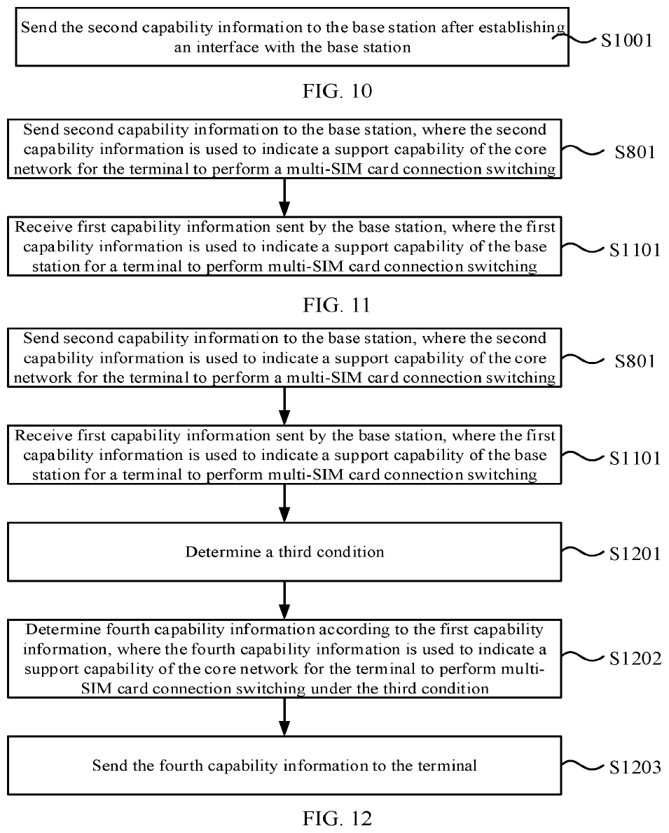

FIG. 10 is a schematic flowchart of another capability indication method according to an embodiment of the present disclosure. As shown in FIG. 10, sending the second capability information to the base station includes the following steps.

In step S1001, after establishing an interface with the base station, the second capability information is sent to the base station.

In an embodiment, the core network may send the second capability information to the base station after establishing an interface with the base station. Accordingly, the information carried by the signaling in the process of establishing the interface can be reduced, thereby reducing the amount of information that the base station needs to parse during the process of establishing the interface, which is beneficial to speeding up the speed of establishing the interface.

In an embodiment, in the case that the core network includes an E-UTRAN core network, the second capability information is carried in a core network configuration update (MME CONFIGURATION UPDATE) signaling. When updating the configuration, the core network may send the core network configuration update signaling to the base station, and carry the second capability information in the signaling and send it to the base station. In addition to the core network configuration update signaling, the core network may also send the second capability information to the base station through other signaling as required.

In an embodiment, in the case that the core network includes an NR core network, the second capability information is carried in an access mobility management function configuration update (AMF CONFIGURATION UPDATE) signaling. When updating the access mobility management function configuration, the core network may send the radio access network configuration update signaling to the base station, and carry the second capability information in the signaling and send it to the base station. In addition to the access mobility management function update signaling, the core network may also send the second capability information to the base station through other signaling as required.

FIG. 11 is a schematic flowchart of another capability indication method according to an embodiment of the present disclosure. As shown in FIG. 11, the method also includes the following steps.

In step S1101, first capability information sent by the base station is received, where the first capability information is used to indicate a support capability of the base station for a terminal to perform multi-SIM card connection switching.

In an embodiment, the base station may generate the first capability information according to its own capability to support multi-SIM card connection switching, and then send the first capability information to the core network. After receiving the first capability information, the core network may determine the support capability of the base station for the terminal to perform multi-SIM card connection switching according to the first capability information, for example, whether it supports multi-SIM card connection switching, for example, in the case of supporting multi-SIM card connection switching, under what conditions does it specifically support multi-SIM card connection switching.

In an embodiment, the first capability information is further used to indicate a support capability of other base station(s) connected to the base station for the terminal to perform the multi-SIM card connection switching.

The communication connection may be established between the base stations by establishing an interface. For example, an interface such as an X2 interface or an Xn interface can be established between the base station A and the base station B. For example, the base station B may be a neighboring base station of the base station A. The base station A and the base station B may communicate through an interface. For example, the base station B may inform the base station A of its support capability for multi-SIM card connection switching, and then the base station A may carry the support capability of the base station A for multi-SIM card connection switching in the first capability information and the support capability of the base station B for multi-SIM card connection switching and send them to the core network.

Accordingly, in the case that there is a communication connection between the core network and the base station, the support capability of at least one base station for multi-SIM card connection switching can be obtained, which is conducive to improving the use efficiency of communication resources between the base station and the core network.

In an embodiment, the method further includes: sending the first capability information (for example, it may be carried by a non-access stratum signaling) to the terminal. It should be noted that the core network may also send the second capability to the terminal.

In an embodiment, the core network may send the first capability information of a plurality of base stations for multi-SIM card connection switching to the terminal, and the terminal may determine its own support capability for multi-SIM card connection switching, and then determine the base station network whose support capability for the multi-SIM card connection switching matches the support capability of the terminal for the multi-SIM card connection switching.

For example, the terminal itself supports multi-SIM card connection switching in the case that the first SIM card remains in the connected state. From the received capability information of a plurality of terminals for multi-SIM card connection switching, it can be determined that the base station X supports the multi-SIM card connection switching in the case that the first SIM card remains in the connected state, and the base station Y only supports multi-SIM card connection switching in the case that the first SIM card leaves the connected state. Then it can be determined that the support capability of the base station X for the multi-SIM card connection switching matches the support capability of the terminal itself for the multi-SIM card connection switching.

Further, for the base station X and the base station Y, the terminal may preferentially select the base station X for access, for example, may preferentially select a cell corresponding to the base station X to perform operations such as camping on and cell reselection. Accordingly, it can be ensured that after the terminal accesses the base station X, when performing multi-SIM card connection switching, after the terminal reports the information of multi-SIM card connection switching to the base station X, the base station X has the ability to make a reasonable configuration for the terminal to perform the multi-SIM card connection switching.

FIG. 12 is a schematic flowchart of another capability indication method according to an embodiment of the present disclosure. As shown in FIG. 12, sending the first capability information to the terminal further includes the following steps.

In step S1201, a third condition is determined.

In step S1202, fourth capability information is determined according to the first capability information, where the fourth capability information is used to indicate a support capability of the core network for the terminal to perform multi-SIM card connection switching under the third condition.

In step S1203, the fourth capability information is sent to the terminal.

In an embodiment, the first capability information may carry a plurality of support capabilities, for example, it may include support for multi-SIM card connection switching, support for multi-SIM card connection switching in the case that the first SIM card remains in the connected state, support for the multi-SIM card connection switching in the case that the first SIM card leaves the connected state, etc. The terminal may not need to determine the support capability of multi-SIM card connection switching for each situation, but only hopes to determine the support capacity for the multi-SIM card connection switching for some situations.

For example, the terminal itself supports multi-SIM card connection switching under the third condition, then the terminal may only need to determine whether the base station also supports multi-SIM card connection switching under the third condition, and is not interested in whether the base station supports multi-SIM card connection switching under other conditions. In this case, the core network may determine the third condition. For example, the third condition can be reported by the terminal, or can be pre-agreed with the terminal, and then the fourth capability information can be determined in the first capability information based on the third condition. The determined fourth capability information is the support capability for multi-SIM card connection switching under the third condition in the first capability information, and then the fourth capability information is sent to the terminal.

Since the fourth capability information is part of the capability information in the first capability information, it generally occupies relatively few communication resources, which can meet the needs of the terminal on the one hand, and help save communication resources on the other hand.

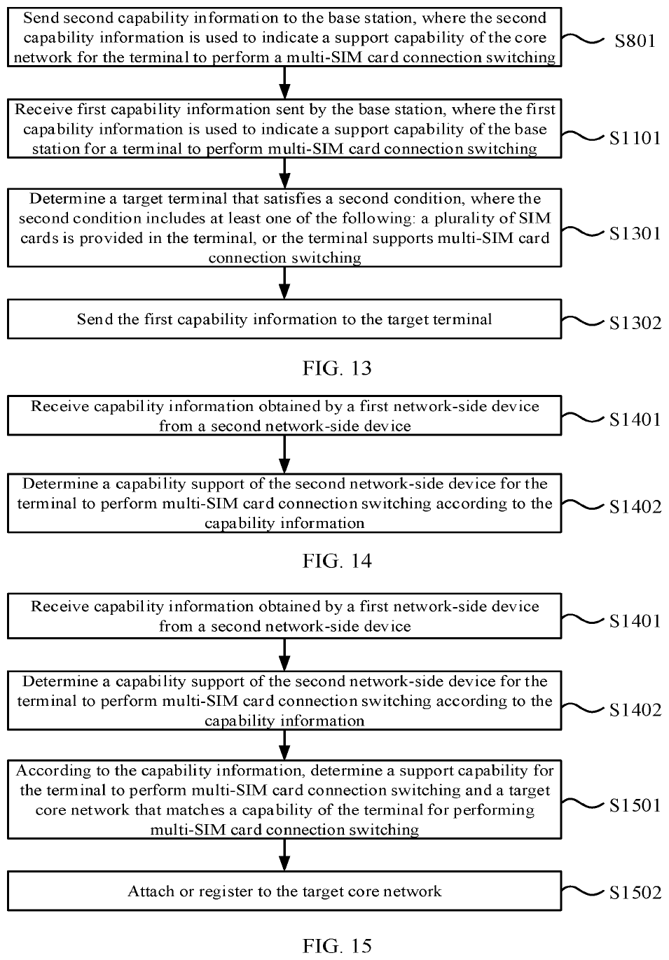

FIG. 13 is a schematic flowchart of another capability indication method according to an embodiment of the present disclosure. As shown in FIG. 13, sending the first capability information to the terminal includes the following steps.

In step S1301, a target terminal that satisfies a second condition is determined, where the second condition includes at least one of the following: a plurality of SIM cards is provided in the terminal, or the terminal supports multi-SIM card connection switching.

In step S1302, the first capability information is sent to the target terminal.

In an embodiment, the core network can selectively send the first capability information to the terminal, for example, it can determine the target terminal that satisfies the second condition, for example, the target terminal can refer to a terminal equipped with a plurality of SIM cards, or can refer to a terminal that supports multi-SIM card connection switching. For these terminals, it is possible for the terminal to perform multi-SIM card connection switching, and then it is necessary to obtain the second capability information. Therefore, it is possible to only send the first capability information to these terminals, which is beneficial to avoiding the waste of the communication resources due to sending the first capability information to the terminal(s) that does not need to obtain the first capability information.

FIG. 14 is a schematic flowchart of a capability determining method according to an embodiment of the present disclosure. The capability determining method shown in this embodiment can be performed by a terminal. The terminal includes but not limited to communication apparatuses such as mobile phones, tablet computers, wearable devices, sensors, and Internet of Things devices. The terminal can communicate with the network-side devices such as base stations and core networks, and the network-side device includes but not limited to the network-side device in 4G, 5G, 6G and other communication systems.

As shown in FIG. 14, the capability determining method may include the following steps.

In step S1401, capability information obtained by a first network-side device from a second network-side device is received.

In step S1402, a capability support of the second network-side device for the terminal to perform multi-SIM card connection switching is determined according to the capability information.

In an embodiment, the terminal is provided with a plurality of SIM cards, the plurality of SIM cards at least includes a first SIM card and a second SIM card, and the multi-SIM card connection switching includes switching to the second SIM card for communication operation during the communication operation through the first SIM card (in this case, the communication operation performed by the first SIM card may be interrupted). It should be noted that the multi-SIM card connection switching is not limited to the above situation, for example, it may also include: when the first SIM card is used for communication operation, the second SIM card is activated to perform communication operation at the same time (in this case, the communication operation performed by the first SIM card may not be interrupted). The technical solutions of the present disclosure will be exemplarily described below mainly for the case where the multi-SIM card connection switching includes switching to the second SIM card for the communication operation when performing the communication operation through the first SIM card.

In view of this situation, the network-side devices, such as base stations and core networks, need to perform appropriate operations and configurations for the terminal. Taking the network-side device including a base station as an example, for example, when a terminal communicates with the first base station through the first SIM card, if it needs to communicate with the second base station through the second SIM card, for example, to receive the system information sent by the second base station, then the communication operation between the first base station and the first SIM card needs to be interrupted for a period of time, and after the communication with the first base station through the second SIM card is completed, the first base station resumes the communication operation with the first SIM card.

However, not all network-side devices support recovery after interruption of the communication operation of the first SIM card. For example, some network-side devices can make appropriate operations and configurations for the terminal to perform multi-SIM connection switching, that is, support multi-SIM card connection switching, while some network-side devices cannot, that is, do not support multi-SIM card connection switching. And for the network-side devices that support multi-SIM card connection switching, the specific support for multi-SIM card connection switching may also be different. For example, the network-side device can support multi-SIM card connection switching when the first SIM card leaves the connected state, or support multi-SIM card connection switching when the first SIM card remains in the connected state.

Considering the above technical problems, in the embodiments of the present disclosure, the second network-side device can generate capability information according to its capability to support multi-SIM card connection switching, and then send the capability information to the first network-side device. After receiving the capability information, the first network-side device can determine the support capability of the second network-side device for the terminal to perform multi-SIM card connection switching according to the capability information, for example, whether it supports multi-SIM card connection switching, for example, in the case of supporting multi-SIM card connection switching, under what conditions does it support multi-SIM card connection switching. Further, the first network-side device may subsequently notify the terminal of the support capability of the second network-side device for multi-SIM card connection switching as required, so that the terminal determines whether to access the second network-side device accordingly.

In an embodiment, the first network-side device includes a base station, and the second network-side device includes a core network; or, the first network-side device includes a core network, and the first network-side device includes a base station.

FIG. 15 is a schematic flowchart of another capability determining method according to an embodiment of the present disclosure. As shown in FIG. 15, the first network-side device includes a base station, and the second network-side device includes a core network, and the method further includes the following steps.

In step S1501, according to the capability information, a support capability for the terminal to perform multi-SIM card connection switching and a target core network that matches the capability of the terminal for performing multi-SIM card connection switching are determined.

In step S1502, the target core network is attached or registered to.

In an embodiment, the base station can send the capability information of a plurality of core networks for multi-SIM card connection switching to the terminal, and the terminal can determine its own support capability for multi-SIM card connection switching, and then determine the core network whose support capability for multi-SIM card connection switching matches the terminal's support capability for multi-SIM card connection switching.

For example, the terminal itself supports multi-SIM card connection switching in the case that the first SIM card remains in the connected state. From the received capability information of a plurality of core networks for multi-SIM card connection switching, it can be determined that the core network X supports the multi-SIM card connection switching in the case that the first SIM card remains in the connected state, and the core network Y only supports multi-SIM card connection switching in the case that the first SIM card leaves the connected state, so it can be determined that the support capability of the core network X for the multi-SIM card connection switching is matched with the support capability of the terminal itself for the multi-SIM card connection switching.

Furthermore, for the core network X and the core network Y, the terminal may preferentially select the core network X to access, for example, may preferentially select the core network X for registration or attachment. Accordingly, it can be ensured that after the terminal accesses the core network X, when performing multi-SIM card connection switching, after reporting the information of the multi-SIM card connection switching to the core network X, the core network X has the ability to make a reasonable configuration for the terminal to perform multi-SIM card connection switching.

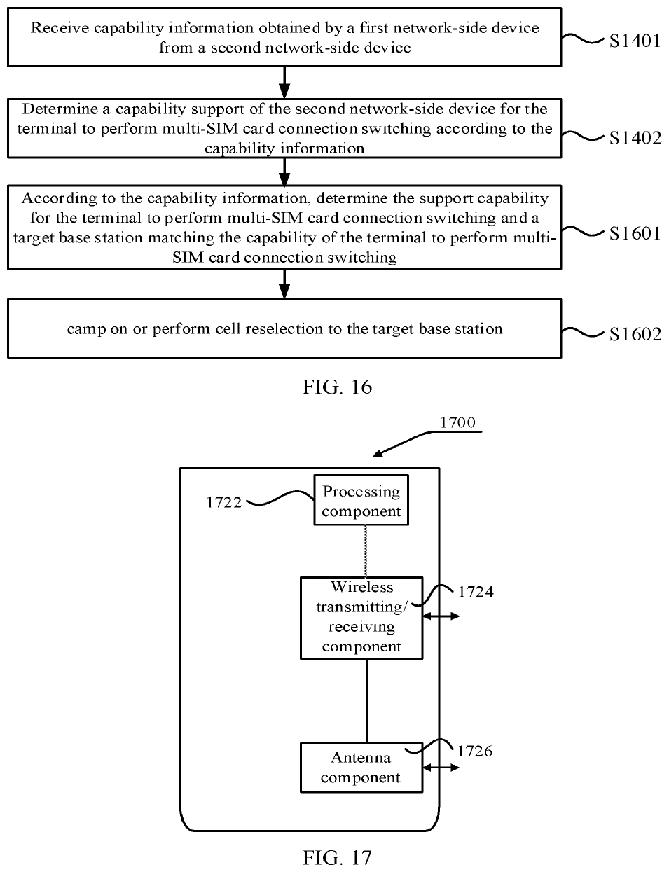

FIG. 16 is a schematic flowchart of another capability determining method according to an embodiment of the present disclosure. As shown in FIG. 16, the first network-side device includes a core network, the second network-side device includes a base station, and the method further includes the following steps.

In step S1601, according to the capability information, the support capability for the terminal to perform multi-SIM card connection switching and a target base station matching the capability of the terminal to perform multi-SIM card connection switching are determined.

In step S1602, camping on or cell reselection is performed to the target base station.

In an embodiment, the core network can send the capability information of a plurality of base stations for multi-SIM card connection switching to the terminal, and the terminal can determine its own support capability for multi-SIM card connection switching, and then determine a base station network whose support capability for multi-SIM card connection switching matches the terminal's support capability for multi-SIM card connection switching.

For example, the terminal itself supports multi-SIM card connection switching in the case that the first SIM card remains in the connected state. From the received capability information of a plurality of terminals for multi-SIM card connection switching, it can be determined that the base station X supports the multi-SIM card connection switching in the case that the first SIM card remains in the connected state, and the base station Y only supports multi-SIM card connection switching in the case that the first SIM card leaves the connected state. Then it can be determined that the support capability of the base station X for the multi-SIM card connection switching matches the support capability of the terminal itself for the multi-SIM card connection switching.

Further, for the base station X and the base station Y, the terminal may preferentially select the base station X for access, for example, may preferentially select a cell corresponding to the base station X to perform operations such as camping on and cell reselection. Accordingly, it can be ensured that after the terminal accesses the base station X, when performing multi-SIM card connection switching, after the terminal reports the information of multi-SIM card connection switching to the base station X, the base station X has the ability to make a reasonable configuration for the terminal to perform multi-SIM card connection switching.

Corresponding to the foregoing embodiments of the capability indicating method and the capability determining method, the present disclosure further provides embodiments of the capability indicating apparatus and the capability determining apparatus.

Embodiments of the present disclosure propose a capability indicating apparatus, which can be applied to a base station, and the base station can communicate with communication devices such as terminals and core networks. The terminals include but not limited to communication devices such as mobile phones, tablet computers, wearable devices, sensors and Internet of Things devices, and the base station includes but not limited to base stations in communication systems such as 4G, 5G, and 6G.

In an embodiment, the terminal may be provided with a plurality of SIM cards, which may be traditional SIM cards or eSIM cards, that is, embedded SIM cards.

The technical solutions of the present disclosure will be exemplarily described below mainly under the condition that a plurality of SIM cards includes a first SIM card and a second SIM card. The first SIM card and the second SIM card do not specifically refer to a certain SIM card, but are used to represent any two different SIM cards among the plurality of SIM cards. The first SIM card and the second SIM card may belong to the same operator, or may belong to different operators, which can be selected according to requirements.

In an embodiment, the apparatus includes one or more processors, and the processors are configured to: send first capability information to the core network, where the first capability information is used to indicate a support capability of the base station for the terminal to perform multi-SIM card connection switching.

In an embodiment, the terminal is provided with a plurality of SIM cards, the plurality of SIM cards at least includes a first SIM card and a second SIM card, and the multi-SIM card connection switching includes switching to the second SIM card to perform a communication operation when performing the communication operation through the first SIM card.

In an embodiment, the first capability information is further used to indicate a support capability of other base station(s) connected to the base station for the terminal to perform the multi-SIM card connection switching.

In an embodiment, the processor is configured to: send the first capability information to the core network during a process of establishing an interface with the core network.

In an embodiment, in the case that the base station includes an Evolved Universal Terrestrial Radio Access Network (E-UTRAN) base station, the first capability information can be carried in S1 interface setup request (S1 SETUP REQUEST) signaling.

In an embodiment, in the case that the base station includes a new air interface (NR) base station, the first capability information is carried in NG interface setup request (NG SETUP REQUEST) signaling.

In an embodiment, the processor is configured to: send the first capability information to the core network after establishing an interface with the core network.

In an embodiment, in the case that the base station includes an E-UTRAN base station, the first capability information is carried in base station configuration update (ENB CONFIGURATION UPDATE) signaling.

In an embodiment, in the case that the base station includes an NR base station, the first capability information is carried in radio access network configuration update (RAN CONFIGURATION UPDATE) signaling.

In an embodiment, the processor is further configured to: receive second capability information sent by the core network, where the second capability information is used to indicate the support capability of the core network for the terminal to perform multi-SIM card connection switching.

In an embodiment, the processor is further configured to: send the second capability information to the terminal.

In an embodiment, the second capability information is carried in radio access control (RRC) signaling and/or system information (SI) and sent to the terminal.

In an embodiment, the second capability information is carried in RRC signaling and sent to the terminal, and the processor is configured to: receive an acquisition request sent by the terminal for the second capability information; send the second capability information to the terminal.

In an embodiment, the processor is configured to: determine a first condition; determine third capability information according to the second capability information, where the third capability information is used to indicate a supporting capability of the core network for the terminal to perform multi-SIM card connection switching under the first condition; send the third capability information to the terminal.

In an embodiment, the processor is configured to: determine a target terminal that meets a second condition, where the second condition includes at least one of the following: a plurality of SIM cards is set in the terminal, or the terminal supports multi-SIM card connection switching; send the second capability information to the target terminal.

Embodiments of the present disclosure propose a capability indicating apparatus, which can be applied to a core network. The core network can communicate with the terminal and the base station. The core network includes but not limited to the core network in 4G, 5G, 6G and other communication systems. The terminal includes but not limited to communication apparatuses such as mobile phones, tablet computers, wearable devices, sensors, and Internet of Things devices.

In an embodiment, the apparatus includes one or more processors, and the processors are configured to: send second capability information to the base station, where the second capability information is used to indicate a support capability of the core network for the terminal to perform multi-SIM card connection switching.

In an embodiment, the terminal is provided with a plurality of SIM cards, the plurality of SIM cards at least includes a first SIM card and a second SIM card, and the multi-SIM card connection switching includes switching to the second SIM card to perform a communication operation when performing the communication operation through the first SIM card.

In an embodiment, the processor is configured to: send the second capability information to the base station during a process of establishing an interface with the base station.

In an embodiment, in the case that the core network includes an E-UTRAN core network, the second capability information can be carried in an S1 interface setup response (S1 SETUP RESPONSE) signaling.

In an embodiment, in the case that the core network includes an NR core network, the second capability information is carried in an NG interface setup response (NG SETUP RESPONSE) signaling.

In an embodiment, the processor is configured to: send the second capability information to the base station after establishing an interface with the base station.

In an embodiment, in the case that the core network includes an E-UTRAN core network, the second capability information is carried in core network configuration update (MME CONFIGURATION UPDATE) signaling.

In an embodiment, in the case that the core network includes an NR core network, the second capability information is carried in an access mobile management function configuration update (AMF CONFIGURATION UPDATE) signaling.

In an embodiment, the processor is further configured to: receive first capability information sent by the base station, where the first capability information is used to indicate a support capacity of the base station for the terminal to perform multi-SIM card connection switching.

In an embodiment, the first capability information is further used to indicate a support capability of other base station(s) connected to the base station for the terminal to perform the multi-SIM card connection switching.

In an embodiment, the processor is further configured to: send the first capability information to the terminal.

In an embodiment, the processor is configured to: determine a third condition; determine fourth capability information according to the first capability information, where the fourth capability information is used to indicate a support capability of the core network for the terminal to perform the multi-SIM card connection switching under the third condition; and send the fourth capability information to the terminal.

In an embodiment, the processor is configured to perform: determining a target terminal that meets a second condition, where the second condition includes at least one of the following: a plurality of SIM cards is provided in the terminal, or the terminal supports multi-SIM card connection switching; sending the first capability information to the target terminal.

Embodiments of the present disclosure also propose a capability determining apparatus, which can be applied to the terminal, including but not limited to communication devices such as mobile phones, tablet computers, wearable devices, sensors, and Internet of Things devices. The terminal can communicate with network-side devices such as base stations and core networks. The network-side devices include but not limited to network-side devices in communication systems such as 4G, 5G, and 6G.

In an embodiment, the apparatus includes one or more processors configured to: receive capability information obtained by the first network-side device from the second network-side device; determine, according to the capability information, a support capability of the second network-side device for the terminal to perform multi-SIM card connection switching.

In an embodiment, the terminal is provided with a plurality of SIM cards, the plurality of SIM cards at least includes a first SIM card and a second SIM card, and the multi-SIM card connection switching includes switching to the second SIM card to perform a communication operation when performing the communication operation through the first SIM card.

In an embodiment, the first network-side device includes a base station, the second network-side device includes a core network, and the processor is further configured to: determine, according to the capability information, a support capability for the terminal to perform the multi-SIM card connection switching and a target core network that matches a capability of the terminal to perform the multi-SIM card connection switching; attach or register with the target core network.

In an embodiment, the first network-side device includes a core network, the second network-side device includes a base station, and the processor is further configured to: determine, according to the capability information, a support capability for the terminal to perform multi-SIM card connection switching and a target base station that matches a capability of the terminal to perform the multi-SIM card connection switching; camp on or perform cell reselection to the target base station.

With regard to the apparatus in the above embodiments, the specific manner in which each module executes operations has been described in detail in the related method embodiments, and will not be described in detail here.

As for the apparatus embodiments, since they basically correspond to the method embodiments, for related parts, the part description of the method embodiments may be referred to. The apparatus embodiments described above are only illustrative, and the modules described as separate components may or may not be physically separated, and the components shown as modules may or may not be physical modules, that is, they may be located in one place, or may be distributed to a plurality of network modules. Part or all of the modules can be selected according to actual needs to achieve the purpose of the solutions of the embodiments. It can be understood and implemented by those skilled in the art without creative effort.

An embodiment of the present disclosure also proposes a communication apparatus, including: a processor; a memory for storing a computer program; where when the computer program is executed by the processor, the capability indicating method executed by the base station described in any of the above embodiments is implemented.

An embodiment of the present disclosure also proposes a communication apparatus, including: a processor; a memory for storing a computer program; where when the computer program is executed by the processor, the capability indicating method executed by the core network described in any of the above embodiments is implemented.

An embodiment of the present disclosure also proposes a communication apparatus, including: a processor; a memory for storing a computer program; where when the computer program is executed by the processor, the capability determining method described in any of the above embodiments is implemented.

An embodiment of the present disclosure also provides a computer-readable storage medium, which is used to store a computer program. When the computer program is executed by a processor, the capability indication method performed by the base station described in any of the above embodiments is implemented.

An embodiment of the present disclosure also provides a computer-readable storage medium for storing a computer program. When the computer program is executed by a processor, the capability indication method performed by the core network described in any of the above embodiments is implemented.

An embodiment of the present disclosure also provides a computer-readable storage medium for storing a computer program. When the computer program is executed by a processor, the capability determining method described in any of the foregoing embodiments is implemented.

As shown in FIG. 17, which is a schematic block diagram of an apparatus 1700 for capability indication according to an embodiment of the present disclosure, the apparatus 1700 may be provided as a base station. Referring to FIG. 17, the apparatus 1700 includes a processing component 1722, a wireless transmitting/receiving component 1724, an antenna component 1726, and a signal processing part specific to the wireless interface. The processing component 1722 may further include one or more processors. One of the processors in the processing component 1722 may be configured to implement the capability indication method described in any of the foregoing embodiments.

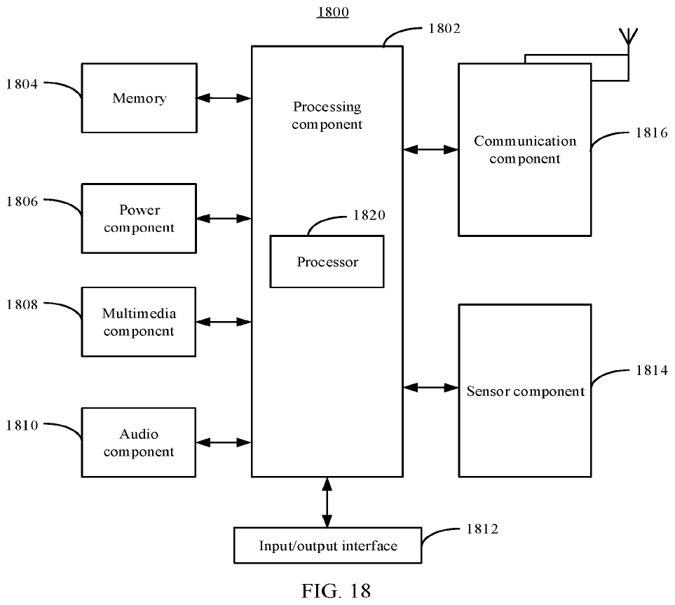

FIG. 18 is a schematic block diagram of an apparatus 1800 for capability determination according to an embodiment of the present disclosure. For example, the apparatus 1800 may be a mobile phone, a computer, a digital broadcast terminal, a messaging device, a gaming console, a tablet, a medical device, exercise equipment, a personal digital assistant, and the like.

Referring to FIG. 18, the apparatus 1800 may include one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 typically controls overall operations of the apparatus 1800, such as the operations associated with display, telephone calls, data communications, camera operations, and recording operations. The processing component 1802 may include one or more processors 1820 to execute instructions to perform all or part of the steps in the above described capability determining method. Moreover, the processing component 1802 may include one or more modules which facilitate the interaction between the processing component 1802 and other components. For example, the processing component 1802 may include a multimedia module to facilitate the interaction between the multimedia component 1808 and the processing component 1802.

The memory 1804 is configured to store various types of data to support the operation of the apparatus 1800. Examples of such data include instructions for any applications or methods operated on the apparatus 1800, contact data, phonebook data, messages, pictures, video, etc. The memory 1804 may be implemented by using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the apparatus 1800. The power component 1806 may include a power management system, one or more power sources, and any other components associated with the generation, management, and distribution of power in the apparatus 1800.

The multimedia component 1808 includes a screen providing an output interface between the apparatus 1800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and/or the rear camera may receive an external multimedia datum while the apparatus 1800 is in an operation mode, such as a photographing mode or a video mode. Each of the front camera and rear camera may be a fixed optical lens system or have focus and optical zoom capability.

The audio component 1810 is configured to output and/or input audio signals. For example, the audio component 1810 includes a microphone (MIC) configured to receive an external audio signal when the apparatus 1800 is in an operation mode, such as a call mode, a recording mode and a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and a locking button.

The sensor assembly 1814 includes one or more sensors to provide status assessments of various aspects of the apparatus 1800. For example, the sensor component 1814 may detect an open/closed state of the apparatus 1800, relative positioning of components, e.g., the display and keypad, of the apparatus 1800, a change in location of the apparatus 1800 or a component of the apparatus 1800, a presence or absence of user contact with the apparatus 1800, an orientation or an acceleration/deceleration of the apparatus 1800 and a change in temperature of the apparatus 1800. The sensor assembly 1814 may include a proximity sensor configured to detect the presence of nearby objects without any physical contact. The sensor component 1814 may also include a light sensor, such as a CMOS or CCD image sensor, for use in imaging applications. In some embodiments, the sensor component 1814 may also include an acceleration sensor, a gyroscope sensor, a magnetic sensor, a pressure sensor or a temperature sensor.

The communication component 1816 is configured to facilitate communication, wired or wirelessly, between the apparatus 1800 and other devices. The apparatus 1800 can access a wireless network based on a communication standard, such as WiFi, 2G or 3G, 4G LTE, 5G NR or a combination thereof. In one exemplary embodiment, the communication component 1816 receives a broadcast signal or broadcast associated information from an external broadcast management system via a broadcast channel. In one exemplary embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 1800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the capability determining method described above.

In an exemplary embodiment, there is also provided a non-transitory computer-readable storage medium including instructions, such as the memory 1804 including instructions, and the above instructions can be executed by the processor 1820 of the apparatus 1800 to implement the above described capability determining method. For example, the non-transitory computer readable storage medium may be a ROM, a random access memory (RAM), a CD-ROM, a magnetic tape, a floppy disk, an optical data storage device, and the like.

Other embodiments of the disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and the embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure is only limited by the appended claims.

It should be noted that in this disclosure, relational terms such as first and second are only used to distinguish one entity or operation from another entity or operation, and do not necessarily require or imply that such actual relationship or order exists between these entities or operations. The term “comprise”, “include” or any other variation thereof is intended to cover a non-exclusive inclusion such that a process, method, article or device including a set of elements includes not only those elements but also other elements that are not expressly listed, or also elements inherent in such a process, method, article, or device. Without further limitations, an element defined by the phrase “including a . . . ” does not exclude the presence of additional identical element in the process, method, article or device including the element.

The methods and apparatuses provided by the embodiments of the present disclosure have been described above in detail. In the present disclosure, specific examples have been used to illustrate the principles and implementations of the present disclosure. The descriptions of the above embodiments are only used to help understand the methods and core ideas of the present disclosure; at the same time, for those of ordinary skill in the art, according to the idea of the present disclosure, there will be changes in the specific implementation and application scope. In summary, the content of this specification should not be understood as limiting the present disclosure.

Obviously, numerous modifications and variations of the present invention are possible in light of the above teachings. It is therefore to be understood that within the scope of the appended claims, the invention may be practiced otherwise than as specifically described herein.

1. A capability indication method, performed by a base station, wherein the method comprises:
sending first capability information to a core network, wherein the first capability information is used to indicate a support capability of the base station for a terminal to perform a multi-SIM card connection switching.

2. The method according to claim 1, wherein the terminal is provided with a plurality of SIM cards, the plurality of SIM cards at least comprises a first SIM card and a second SIM card, and the multi-SIM card connection switching comprises switching to the second SIM card for a communication operation when performing the communication operation through the first SIM card.

3. The method according to claim 1, wherein the first capability information is further used to indicate a support capability of other base station connected to the base station for the terminal to perform the multi-SIM card connection switching.

4. The method according to claim 1, wherein sending the first capability information to the core network comprises:
in a process of establishing an interface with the core network, sending the first capability information to the core network.

5. The method according to claim 4, wherein in a case that the base station comprises an Evolved Universal Terrestrial Radio Access Network (E-UTRAN) base station, the first capability information can be carried in an S1 interface setup request (S1SETUP REQUEST) signaling.

6. The method according to claim 4, wherein in a case that the base station comprises a New Radio (NR) base station, the first capability information is carried in an NG interface setup request (NG SETUP REQUEST) signaling.

7. The method according to claim 1, wherein sending the first capability information to the core network comprises:
after establishing an interface with the core network, sending the first capability information to the core network.

8. The method according to claim 7, wherein in a case that the base station comprises an E-UTRAN base station, the first capability information is carried in a base station configuration update (ENB CONFIGURATION UPDATE) signaling.

9. The method according to claim 7, wherein in a case that the base station comprises an NR base station, the first capability information is carried in a radio access network configuration update (RAN CONFIGURATION UPDATE) signaling.

10. The method according to claim 1, further comprising:
receiving second capability information sent by the core network, wherein the second capability information is used to indicate a support capability of the core network for the terminal to perform the multi-SIM card connection switching.

11. The method according to claim 10, further comprising:
sending the second capability information to the terminal.

12. The method according to claim 11, wherein the second capability information is carried in a radio resource control (RRC) signaling and/or system information (SI) and sent to the terminal.

13. The method according to claim 12, wherein the second capability information is carried in the RRC signaling and sent to the terminal, and sending the second capability information to the terminal comprises:
receiving an acquisition request for the second capability information sent by the terminal; and
sending the second capability information to the terminal.

14. The method according to claim 12, wherein sending the second capability information to the terminal comprises:
determining a first condition;
determining third capability information according to the second capability information, wherein the third capability information is used to indicate a support capability of the core network for the terminal to perform the multi-SIM card connection switching under the first condition; and
sending the third capability information to the terminal.

15. The method according to claim 11, wherein sending the second capability information to the terminal comprises:
determining a target terminal that satisfies a second condition, wherein the second condition comprises at least one of following: a plurality of SIM cards is provided in the terminal, or the terminal supports the multi-SIM card connection switching; and
sending the second capability information to the target terminal.

16. A capability indication method, performed by a core network, wherein the method comprises:
sending second capability information to a base station, wherein the second capability information is used to indicate a support capability of the core network for a terminal to perform a multi-SIM card connection switching.

17. The method according to claim 16, wherein the terminal is provided with a plurality of SIM cards, the plurality of SIM cards at least comprises a first SIM card and a second SIM card, and the multi-SIM card connection switching comprises switching to the second SIM card for a communication operation when performing the communication operation through the first SIM card.

18. The method according to claim 16, wherein sending the second capability information to the base station comprises:
in a process of establishing an interface with the base station, sending the second capability information to the base station.

19. The method according to claim 18, wherein in a case that the core network comprises an E-UTRAN core network, the second capability information can be carried in an S1 interface setup response (S1 SETUP RESPONSE) signaling.

20. The method according to claim 18, wherein in a case that the core network comprises an NR core network, the second capability information is carried in an NG interface setup response (NG SETUP RESPONSE) signaling.

21. The method according to claim 16, wherein sending the second capability information to the base station comprises:
after establishing an interface with the base station, sending the second capability information to the core network.

22. The method according to claim 21, wherein in a case that the core network comprises an E-UTRAN core network, the second capability information is carried in a core network configuration update (MME CONFIGURATION UPDATE) signaling.

23. The method according to claim 21, wherein in a case that the core network comprises an NR core network, the second capability information is carried in an access mobile management function network configuration update (AMF CONFIGURATION UPDATE) signaling.

24. The method according to claim 16, further comprising:
receiving first capability information sent by the base station, wherein the first capability information is used to indicate a support capability of the base station for the terminal to perform the multi-SIM card connection switching.

25. The method according to claim 24, wherein the first capability information is further used to indicate a support capability of other base station connected to the base station for the terminal to perform the multi-SIM card connection switching.

26. The method according to claim 25, further comprising:
sending the first capability information to the terminal.

27. The method according to claim 26, wherein sending the first capability information to the terminal comprises:
determining a third condition;
determining fourth capability information according to the first capability information, wherein the fourth capability information is used to indicate a support capability of the core network for the terminal to perform the multi-SIM card connection switching under the third condition;
sending the fourth capability information to the terminal.

28. The method according to claim 26, wherein sending the first capability information to the terminal comprises:
determining a target terminal that meets a second condition, wherein the second condition comprises at least one of following: a plurality of SIM cards is provided in the terminal, or the terminal supports the multi-SIM card connection switching;
sending the first capability information to the target terminal.

29. A capability determining method, performed by a terminal, wherein the method comprises:
receiving capability information obtained by a first network-side device from a second network-side device; and
determining, according to the capability information, a support capability of the second network-side device for the terminal to perform a multi-SIM card connection switching.

30. The method according to claim 29, wherein the terminal is provided with a plurality of SIM cards, the plurality of SIM cards at least comprises a first SIM card and a second SIM card, and the multi-SIM card connection switching comprises switching to the second SIM card for a communication operation when performing the communication operation through the first SIM card.

31. The method according to claim 29, wherein the first network-side device comprises a base station, and the second network-side device comprises a core network, and the method further comprises:
determining, according to the capability information, a support capability for the terminal to perform the multi-SIM card connection switching and a target core network that matches a capability of the terminal to perform the multi-SIM card connection switching; and
attaching or registering to the target core network.

32. The method according to claim 29, wherein the first network-side device comprises a core network, and the second network-side device comprises a base station, and the method further comprises:
determining, according to the capability information, a support capability for the terminal to perform the multi-SIM card connection switching and a target base station that matches a capability of the terminal to perform the multi-SIM card connection switching; and
camping on or performing a cell reselection to the target base station.

33-35. (canceled)

36. A communication apparatus, comprising:
a processor; and
a memory for storing a computer program;
wherein when the computer program is executed by the processor, the capability indication method according to claim 1 is implemented.

37. A communication apparatus, comprising:
a processor; and
a memory for storing a computer program;
wherein when the computer program is executed by the processor, the capability indication method according to claim 16 is implemented.

38. A communication apparatus, comprising:
a processor; and
a memory for storing a computer program;
wherein when the computer program is executed by the processor, the capability determining method according to claim 29 is implemented.

39-41. (canceled)
